(19) United States
(12) Patent Application Publication
(10) Pub. No.: US 2010/0131424 A1
(43) Pub. Date: May 27, 2010

(54) SYSTEM AND METHOD FOR MANAGING AND INDEMNIFYING COMMERCIAL PAPER

(75) Inventors: Christopher Scott Mosé, New York, NY (US); Chaolun H. Jin, New York, NY (US)

Correspondence Address: PILLSBURY WINTHROP SHAW PITTMAN, LLP, P.O. BOX 10500, MCLEAN, VA, 22102, US

(73) Assignee: THE BANK OF NEW YORK MELLON, New York, NY (US)

(21) Appl. No.: 12/621,791

(22) Filed: Nov. 19, 2009

Related U.S. Application Data
(60) Provisional application No. 61/117,070, filed on Nov. 21, 2008.

(51) Int. Cl. G06Q 40/00

(52) U.S. Cl. 705/36 R; 705/37; 705/38

(57) ABSTRACT

In various embodiments, a computer-implemented method and system of managing and indemnifying commercial paper by a trustee over a computer network includes receiving, in a processor and over the network, an indication of a proposed short-term secured investment transaction from one or more parties to the transaction, said indication including one or more illiquid and non-current assets proposed as collateral for the investment transaction; evaluating, by the processor, an asset value of the one or more illiquid and non-current assets; applying, by the processor, a discount factor to the asset value in response to either an operator input or a predetermined discount factor stored in a database, or a combination thereof; determining, by the processor, whether the applied discount factor and a resulting discounted asset value is acceptable to the trustee and at least one party to the proposed secured investment transaction that is considering providing investment funds for the transaction; if the resulting discounted asset value is acceptable to the trustee and the at least one party, and if the proposed secured investment transaction is consummated, establishing, by the processor, a trust account in a database in which at least documents representing a transfer of title of the one or more illiquid and non-current assets are stored.

### CROSS-REFERENCE TO RELATED APPLICATIONS

This application claims benefit under 35 U.S.C. §119(e) to co-pending U.S. Provisional Application Ser. No. 61/117,070 filed on Nov. 21, 2008, the entire contents of which are incorporated herein by reference.

### BACKGROUND

Definitions of various terms pertinent to this disclosure are provided in Table 1 of the accompanying Appendix.

Periodically, business and financial markets experience turmoil and uncertainty, partly as a result of business cycle fluctuations, but also due to specific financial events or series of events which adversely affect the global business environment. Such adverse effects include increased liquidity and credit risks for both creditors and lenders in connection with securing business financing, particularly short-term financing.

Usually, illiquid or non-current assets secure long-term financing. Examples of illiquid or non-current assets used for collateral in long-term financing include secured/asset-based loans, sale-and-leaseback arrangements, or even a company's buildings or land.

In the global money market, commercial paper (CP) is an unsecured promissory note with a fixed maturity of one to 270 days. Commercial Paper is a money-market security issued (sold) by large banks and corporations to get money to meet short term debt obligations (e.g., payroll), and is only backed by an issuing bank or corporation's promise to pay the face amount on the maturity date specified on the note. Since it is not backed by collateral, only firms with excellent credit ratings from a recognized rating agency will be able to sell their commercial paper at a reasonable price. Commercial paper is usually sold at a discount from face value, and carries shorter repayment dates than bonds. The longer the maturity on a note, the higher the interest rate that must be paid. Interest rates fluctuate with the market, but are typically lower than banks' rates.

Money market funds are the largest buyers of commercial paper, purchasing about a third of outstanding paper. Other buyers include retirement and pension funds, corporate treasuries and life insurance companies. Commercial paper generally offers a higher yield than other short-term assets like Treasurys and certificates of deposit.

If commercial paper is not available for a borrower, short-term financing may offer unique challenges due to the illiquid nature of the assets available to collateralize any short-term loan. For example, short-term financing, if secured or collateralized, is usually secured with either marketable securities or current assets. Examples of such collateral include asset-backed commercial paper (ABCP) and sale and repurchase agreements (repos).

ABCP is a form of commercial paper that is collateralized by other financial assets. ABCPs are typically short-term investments that mature between 90 and 180 days and are typically issued by a bank or other financial institution. They are designed to be used for short-term financing needs.

An institution wishing to issue ABCP sells its assets to a bankruptcy-remote special purpose vehicle (SPV) or structured investment vehicle (SIV), created by financial services companies, to issue the ABCP. This allows for the issuing institution to be legally separated from the SPV. The financial assets that serve as collateral for ABCP are ordinarily a mix of many different assets, which are jointly judged to have a low risk of bankruptcy by a ratings agency. However, in 2007-2008 many of these assets performed more poorly than expected, making buyers much less willing to purchase ABCP.

If markets became unwilling to purchase ABCP, this may cause trouble for financial institutions that rely on sales of ABCP to obtain funds for use in longer-term investments. In particular, the structured investment vehicles (“SIVs” or “conduits”) set up by some commercial banks financed their longer-term, higher-yield investing through sales of ABCP. This can be very profitable when ABCP is considered safe (so that ABCP buyers accepted a low interest rate), but forced SIVs to quickly liquidate their longer-term investments, at a substantial loss, when they were no longer able to sell ABCP.

A Sale and Repurchase Agreement, better known as Repurchase Agreements (RPs or “repos”), has a borrower (seller/cash receiver) sell securities for cash to a lender (buyer/cash provider) and agree to repurchase those securities at a later date for more cash. The repo rate is the difference between borrowed and paid back cash expressed as a percentage. Repurchase agreements are financial instruments used in money markets and capital markets. A repo is economically similar to a secured loan, with the buyer receiving securities as collateral to protect against default. There is little that prevents any security from being employed in a repo such that Treasury or Government bills, corporate and Treasury/Government bonds, and stocks/shares may all be used as securities involved in a repo. However, the legal title to the securities clearly passes from the seller to the buyer, or “investor”. Coupons (installment payments that are payable to the owner of the securities) which are paid while the repo buyer owns the securities are, in fact, usually passed directly onto the repo seller which might seem counterintuitive, as the ownership of the collateral technically rests with the buyer during the repo agreement. It is possible to instead pass on the coupon by altering the cash paid at the end of the agreement, though this is more typical of Sell/Buy Backs.

Although the underlying nature of the repo transaction is that of a loan, the terminology differs from that used when talking of loans because the seller does actually repurchase the legal ownership of the securities from the buyer at the end of the agreement. Although the actual effect of the whole transaction is identical to a cash loan, in using the “repurchase” terminology, the emphasis is placed upon the current legal ownership of the collateral securities by the respective parties.

A Sell/Buy Back is the spot sale and a forward repurchase of a security. The basic motivation of Sell/Buy Backs is generally the same as for a classic repo, i.e., attempting to benefit from the lower financing rates generally available for collateralized as opposed to non-secured borrowing. The economics of the transaction are also similar with the interest on the cash borrowed through the sell/buy back being implicit in the difference between the sale price and the purchase price.

However, even with these conventional short-term financing mechanisms, short-term financing may still not be easily obtained due to a general lack of liquidity in a “frozen” commercial paper market in which credit-worthy borrowers are unable to find short-term financing. For example, many borrowers have completely used existing bank lines of credit and are unlikely to be able to increase their credit line during times of credit market dislocations.

Temporary market dislocations such as described above come and go over time. However, during the duration of such market dislocations, asset-rich but cash-poor borrowers without the ability to execute a repo agreement or who have illiquid assets that it prefers not to sell, e.g., leases, licenses, patents come up property, plant, equipment, networks, etc., are unable to obtain greatly needed short-term financing for day-to-day operations due to the few options available.

FIG. 1 provides a comparison of various available financing options and indicates that, for illiquid, non-current assets, there is no current market mechanism which provides the ability to obtain short-term financing. Such illiquid, non-current assets may be the only assets that a business has available for collateral. However, the lender or buyer of a debt instrument collateralized by such illiquid non-current assets faces a significant liquidity risk under existing financing structures. This liquidity risk is due to the lack of an established market for the underlying collateral, including the inherent liquidity risk associated with the use of non-current assets for short-term loan collateral.

FIG. 2 further illustrates difficulties in obtaining short-term financing. For example FIG. 2A shows a dramatic decline in outstanding commercial paper since the end of 2006, and FIG. 2B shows a dramatic increase in the interest rate spread of commercial paper with respect to the Federal Funds (FF) rate.

FIG. 3 illustrates a conventional “dealer paper” business model in which a seller (e.g., Wal-Mart) obtains short-term funding from an investor (e.g., a money market mutual fund) through a dealer/underwriter (e.g., Goldman Sachs or JP Morgan) for a fee, typically 5-10 basis points. This model does not work well during periods of economic turmoil or market dislocations that reduce the amount of investment funding available at acceptable interest rates.

In this regard, there are no established market mechanisms for collateral management of illiquid non-current assets which may be the only assets available for short-term financing. Valuations of such collateral can be crucial to protect lenders, particularly during market downturns. Conventional computer/Internet based systems exist between principal counterparties for collateral and liquidity management of more traditional transaction types such as tri-party repurchase agreements, portfolio swaps, collateralized loans, swap collateralization deals, for example. One example of an Internet-based conventional collateral management system interposed between buyers and sellers and providing services to them is RepoEdge®, owned and operated by the Bank of New York Mellon. RepoEdge® provides real-time links into the Federal Reserve Bank as well as securities clearing operations such as Euroclear and the Depository Trust Corporation. AccessEdge® is a browser-based portal that serves as a user interface to RepoEdge®. However, these and other existing systems do not account for the particular concerns connected with the use of illiquid non-current assets as collateral and short-term financing arrangements.

What is needed then, is a system and method for overcoming the liquidity mismatch between a borrower's illiquid, non-current assets that it prefers not to sell, and which facilitates the provision of much-needed short-term financing. What is further needed is a computerized system and method for facilitating short-term financing over a computer network, e.g., the Internet.

### SUMMARY

Various embodiments and aspects of this disclosure are directed to a computer-implemented system and method for indemnifying commercial paper in which a tri-party collateral model is used to mitigate liquidity and credit risks for 2a-7-type investors when securing short-term financing with illiquid, non-current assets. As discussed above, short-term financing, if secured, is secured with either marketable securities or current assets, for example ABCP and repos. Usually, illiquid or non-current assets secure long-term financing. Examples include secured/asset-based loans and sale-and-leaseback. In contrast, the system and method of the present disclosure provide indemnified CP that uses a tri-party model to mitigate the liquidity risk of using illiquid/non-current assets to provide credit support for a commercial paper program.

To mitigate investment risk, in one or more embodiments, valuable illiquid non-current assets that a borrower owns and prefers not to sell are held in trust as deeply discounted collateral, for example at a relatively low loan to value (LTV) ratio such as 30%. The borrower retains the economic ownership of the asset with expected future use but does not realize gains or losses. At maturity, the trustee would return the collateral in a manner similar to a repo transaction. In other aspects of this disclosure, and in the event of default by the borrower, the trustee and/or a central banking authority e.g. the Federal Reserve bank, may be obligated to purchase a discount bond issued by the trust to finance repayment of the defaulted commercial paper. The trustee could then repay the discount bond with the sale of the asset which, if held at a low LTV, would likely fully repay the lender/investor.

This type of new business model introduces a new type of investor segment. For example with the method and system of the present disclosure, there is a potential for related corporate and other “cash-rich” strategic investors to purchase this specialized type of commercial paper. For example strategic lenders such as private equity/venture capital funds may be interested in purchasing assets at bargain prices and, if default occurs, they may take possession of the asset at a deep discount for their use of the asset or with a pre-arranged workout plan. In the case of existing financial investors such as money market funds, they generally would have no interest in taking possession of the asset at any price. In this case, the trustee/platform manager or central banking authority may indemnify the investor against liquidity mismatch by paying upfront, and then liquidating assets at a later time when market conditions may be more favorable, providing additional leverage against the low LTV at which the financing was granted.

The advantages and benefits of this novel approach for the lender include the receipt of higher risk-adjusted returns on cash, with less counterparty risk. The borrower regains access to liquidity during market dislocations, pays lower rates than alternatives, and retains future use of assets without realized gains or losses. Further, the safety of the collateral is assured. For the trustee/platform manager, e.g., a bank, their benefits include earned collateral/trust fees, interest income and a likely high Return on Assets (ROA) during a workout arrangement. Benefits to the central banking authority, e.g., the Federal Reserve Bank in the United States, and ultimately taxpayers, include suffering no credit risk, receiving fair compensation for the liquidity provided, and providing liquidity only in the case of default.

The method and system of the present disclosure provide previously unavailable private financing solutions as well as a better solution for central banking authorities. For example, the U.S. Federal Reserve initiated a $250 billion purchase of commercial paper in October 2008. Although this was intended to provide benefits to corporate borrowers by providing “below market” financing during dislocation without additional commitment or fee, taxpayers suffer 100% of the credit risk of unsecured business loans with “below-market” returns, since taxpayers purchase 100% of the debt at “below-market” rates.

In contrast, the system and method of the present disclosure provides indemnified commercial paper which has the ability to provide benefits to the Federal Reserve and taxpayers by mitigating 100% of the credit risk by the borrower's collateral at relatively low LTV ratios. Further, taxpayers provide liquidity only in cases of default, and fair compensation is provided for any liquidity that does become necessary.

In one embodiment, a computer-implemented method of managing and indemnifying commercial paper by a trustee over a computer network includes receiving, in a processor and over the network, an indication of a proposed short-term secured investment transaction from one or more parties to the transaction, said indication including one or more illiquid and non-current assets proposed as collateral for the investment transaction; evaluating, by the processor, an asset value of the one or more illiquid and non-current assets; applying, by the processor, a discount factor to the asset value in response to either an operator input or a predetermined discount factor stored in a database, or a combination thereof; determining, by the processor, whether the applied discount factor and a resulting discounted asset value is acceptable to the trustee and at least one party to the proposed secured investment transaction that is considering providing investment funds for the transaction; if the resulting discounted asset value is acceptable to the trustee and the at least one party, and if the proposed secured investment transaction is consummated, establishing, by the processor, a trust account in a database in which at least documents representing a transfer of title of the one or more illiquid and non-current assets are stored.

In another embodiment, a computer-implemented system for managing and indemnifying commercial paper by a trustee over a computer network includes a processor operatively coupled to the network; one or more memory devices operatively coupled to the processor, said one or more memory devices including one or more structured databases therein configured to store information relating at least to the commercial paper; said processor being configured to: receive an indication of a proposed short-term secured investment transaction from one or more of parties to the transaction, said indication comprising one or more illiquid and non-current assets proposed as collateral for the investment transaction; evaluate an asset value of the one or more illiquid and non-current assets; receive one or more operator inputs; apply a discount factor to the asset value in response to either the operator input or a predetermined discount factor stored in the structured database, or a combination thereof; determine whether the applied discount factor and a resulting discounted asset value is acceptable to the trustee and at least one party to the proposed secured investment transaction that is considering providing investment funds for the transaction; wherein, if the resulting discounted asset value is acceptable to the trustee and the at least one party, and if the proposed secured investment transaction is consummated, the processor is configured to establish a trust account in the structured database in which at least documents representing a transfer of title of the one or more illiquid and non-current assets are stored.

In yet another embodiment, a computer-implemented document browser application for a managing and indemnifying commercial paper by a trustee over a computer network includes a processor configured to execute instructions therein such that a software interface with an Internet Web browser enables the application to run within a Web browser window so as to allow a user to manage a proposed short-term secured investment transaction. A user interface may be enabled with a host computer system in which allows the user to receive an indication of a proposed short-term secured investment transaction from one or more of parties to the transaction. The indication may include one or more illiquid and non-current assets proposed as collateral for the investment transaction. The browser application may also evaluate an asset value of the assets offered as collateral.

### BRIEF DESCRIPTION OF THE DRAWINGS

Various exemplary embodiments of this disclosure will now be described with reference to the accompanying drawings in which:

FIG. 1 provides a comparison of various types of loan terms and collateral with financial products that are currently available, along with risks and issues associated therewith;

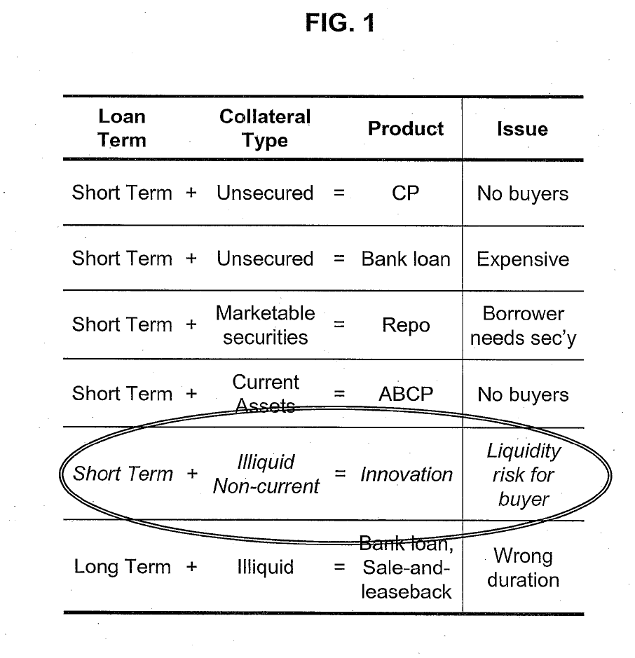

FIG. 2 illustrates the effects of a so-called market dislocation in which commercial paper becomes less available and more expensive over time;

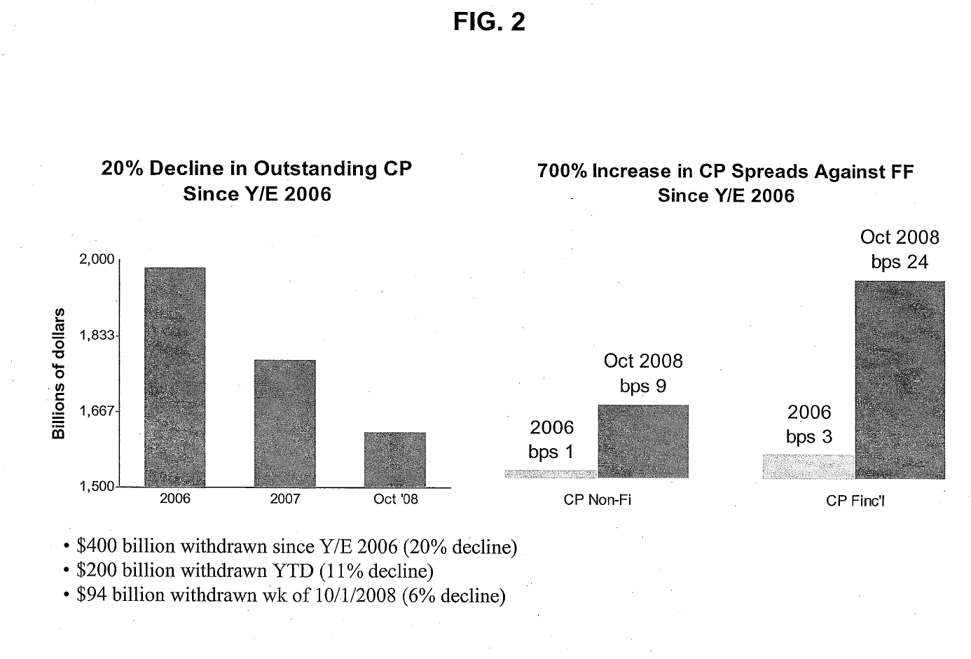

FIG. 3 illustrates a conventional short-term funding mechanism/process which is insufficient to provide short-term funding during periods of market dislocation, particularly for certain types of asset such as illiquid and non-current assets;

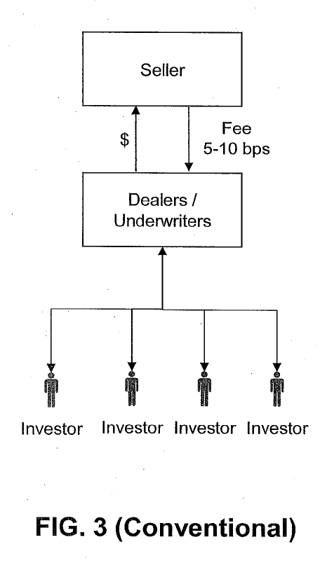

FIG. 4 illustrates an embodiment of a block diagram of a computer network implemented system for managing and indemnifying commercial paper by a trustee; and

FIG. 5 provides an alternative depiction of a system for managing and indemnifying commercial paper by a trustee.

### DETAILED DESCRIPTION

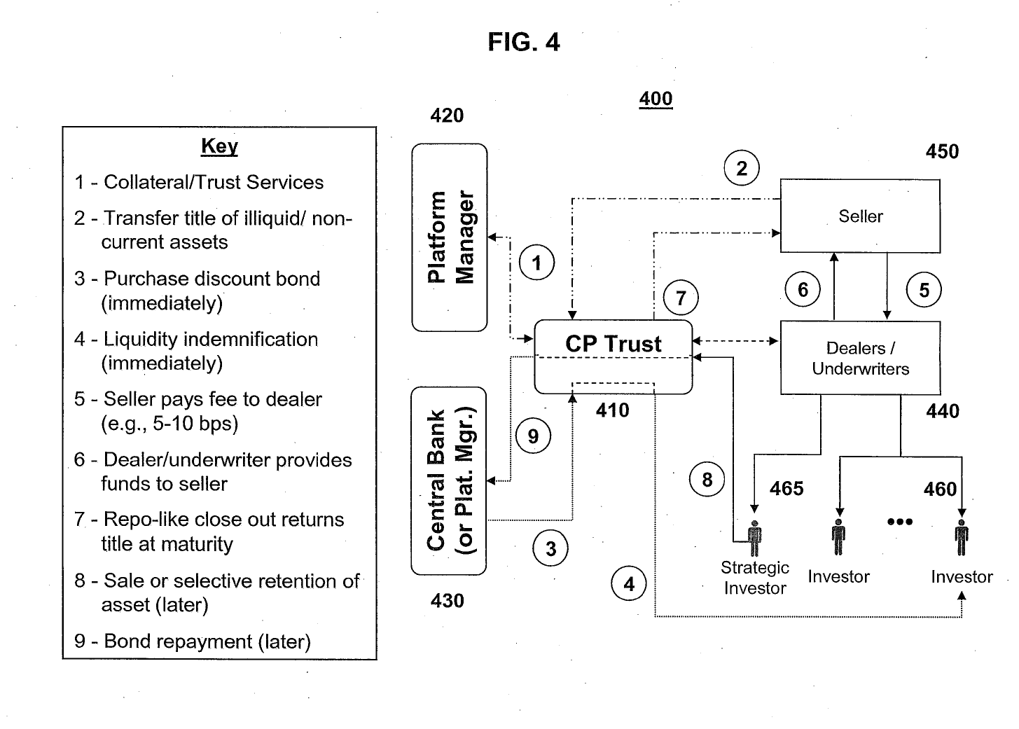

Turning now to FIG. 4, an embodiment of a system for managing and indemnifying commercial paper is illustrated in which system 400 includes CP trust engine 410 operatively connected to platform manager 420. It should be noted that functionality associated with platform manager 420 may be incorporated directly into CP trust engine 410, or may be provided as a separate stand-alone application program. It should also be understood that the various functionality described herein with respect to various elements of system 400 may be carried out by one or more computers and/or computer processors and peripheral devices connected in a conventional manner, including networked devices. Various network devices indicated herein may be interconnected via the Internet or by a private computer network.

In this context, the terms “computer” and “computer processor” are intended to have a broad definition that includes various devices with data processing capability, such as mobile phones, electronic paper/readers, personal data assistants (PDA), workstations, and tablet or laptop PCs, for example.

System 400 may further include an interface to a central banking authority 430 (e.g., Federal Reserve) which may include a computer workstation through which financial activities associated with system 400 may be monitored and/or initiated by central banking authorities. Optionally, an interface may be provided between dealers/underwriters 440 and CP trust engine 410 to allow monitoring of activity associated with a particular dealers/underwriter. System 400 also includes an interface with a seller 450 who is attempting to sell commercial paper backed by illiquid/non-current assets. Investors 460 and/or strategic investors 465 may have one or more network interfaces with dealer underwriters 440 and/or CP trust engine 410. It should be noted that strategic lenders 465 are a new class of investors previously without access to this type of investment, i.e., commercial paper with illiquid, non-current assets as collateral.

A description of an exemplary embodiment of a method of managing and indemnifying commercial paper using computer-implemented system 400 will now be described with respect to the circled numbers 1-9 illustrated in FIG. 4.

1. Platform manager 420, e.g., a bank or other qualified financial institution, offers collateral management/trust services as an intermediary between seller 450 and/or investor 460 and strategic investor 465.

2. Seller 450 transfers title of illiquid/non-current assets to investor 460. Platform manager 420 holds this title in trust for the eventual return to the seller upon satisfaction of the debt obligation, or for liquidation in the event of default.

3. For a non-strategic lender (e.g., a money market fund with no interest in retaining the asset in the event of default), Central Bank 430 (or, in another aspect of this embodiment, Platform Manager 420) purchases a discount bond in the event of loan default by seller 450, and CP trust engine 410 registers details of the bond in a database (not shown).

4. As the result of the bond purchase, liquidity indemnification is provided to investor 460 via CP trust engine 410.

5. Seller 450 pays a fee to dealer (e.g., 5-10 bps).

6. Dealer/underwriter 440 provides funds from investor 460 and/or strategic investor 465 to seller 450. (Note: the funds may be provided via CP trust engine 410 rather than directly by investor 460).

7. Repo-like close out returns title to seller 450 at maturity (if no default).

8. In the event of default by seller 450, Strategic Investor 465 may either sell or retain the asset.

9. Bond repayment (in the event of default) is made.

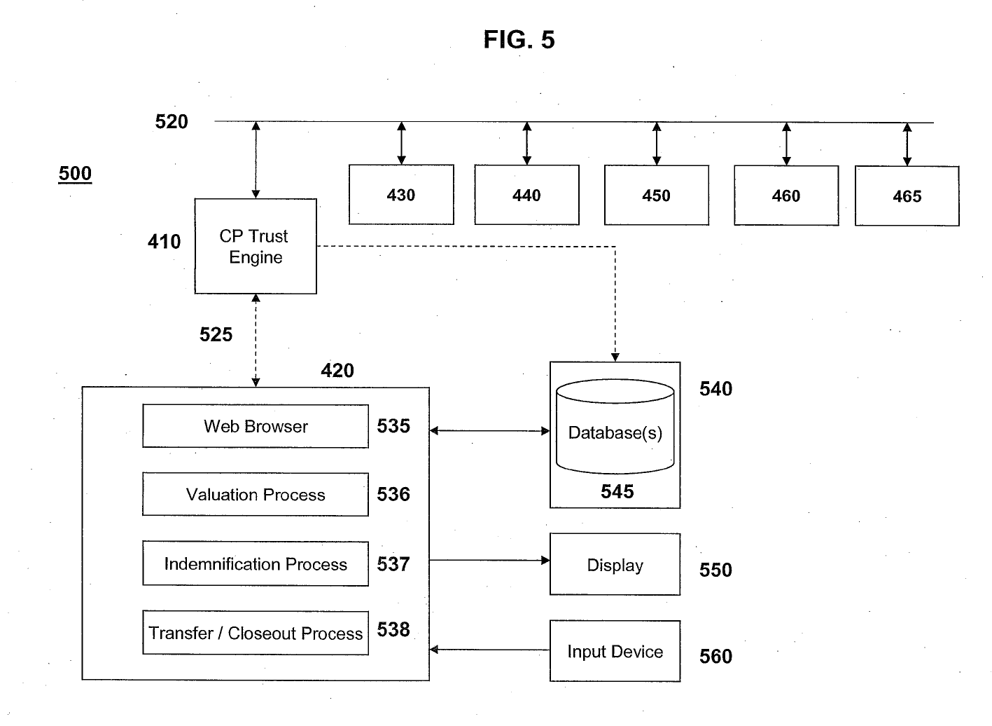

An alternative depiction of a system for managing and indemnifying commercial paper is illustrated in FIG. 5. System 500 includes CP trust engine 410 operatively connected to network 520, which may be for example, the Internet. CP trust engine 410 is also coupled to platform manager 420 via network connection 525, which may be a local area network or the Internet. Platform manager 420 includes various functionality represented in a modular fashion by Web browser 535, valuation process 536, indemnification process 537, and transfer/closeout process 538. Platform manager 420 includes interfaces with memory device 540, which includes one or more databases 545. In addition, interfaces are provided to display 550 and input device 560. Other architectures are possible. For example, the dashed lines of FIG. 5 represent alternative embodiments in which the functionality of platform manager 420 is incorporated directly in CP trust engine 410, which would have an interface with memory 540 and/or database 545.

As also illustrated in FIG. 5, each of Central Bank 430, dealers/underwriters 440, seller 450, investors 460, and/or strategic investor 465 may also be interfaced to CP trust engine 410 via network 520. Each of these entities would have at least basic web and processing functionality incorporated therein, similar at least in some respects to the web browser functionality 535 represented in platform manager 420.

In various embodiments, Platform manager 420 and/or CP trust engine 410 may establish a trust to maintain positive control of collateralized assets related to a financial transaction, for example, illiquid non-current assets used as collateral for short-term financing as discussed above.

Various documents may be necessary to establish, maintain, and consummate the types of financial transaction envisioned by the present disclosure. Such documents may be stored in conventional ways, including in structured database 545 in computer memory 540. A data structure in computer science is a way of storing data in a computer so that it can be used efficiently, and is an organization of mathematical and logical concepts of data. Choice of the data structure can allow an efficient algorithm to be used. A well-designed data structure allows a variety of operations to be performed, using as few resources, both execution time and memory space, as possible. Data structures may be implemented by a programming language as data types and the references and operations they provide.

The processors in CP trust engine 410 and/or platform manager 420 may include various conventional processes and functionality associated with network and/or stand-alone computing, as well as various functionality associated with processes of the present disclosure. More than one processor may be used. Further, Web browser functionality 535 may be implemented as a conventional web browser such as Internet Explorer® or Firefox®, and which is connected to the Internet via network connection 525. Although FIG. 5 implies use of the Internet, and as mentioned above, the system and method of the present disclosure may also be useful in a private network arrangement, and is not limited to the Internet. In addition, a Web server node may be implemented in a variety of ways known in the art to transfer information over computer networks 520 and 525.

Memory 540 may be connected to a standard manner with CP trust engine 410 and/or platform manager 420, and may include one or more structured databases 545. Memory 540 may be implemented in a variety of known ways, for example by a hard drive or removable storage or others storage devices. The data may be formatted in a desired manner that lends itself to be stored in a structured database. Multiple memories and/or backup memory storage may also be implemented, including use of special purpose servers which is optimized or configured for secure access to sensitive documents relating to various financial transactions.

Display 550 and input device 560 may be conventional computer peripheral devices which have respective interfaces with a processor to allow input and display of data by a system manager and/or administrator (not shown), e.g. a bank.

As discussed above, retrieved documents may include trust-related documents which may be considered to be confidential information.

Further discussion of embodiments of the present disclosure are provided below. For example, in one embodiment, a computer-implemented method of managing and indemnifying commercial paper by a trustee/platform manager 420 over a computer network 520 includes receiving an indication of a proposed short-term secured investment transaction from one or more parties to the transaction (450, 460, 465) in a processor (410 and/or 420) from the network 520. The indication may include identification of or more illiquid and non-current assets proposed as collateral for the investment transaction.

An asset value of the one or more illiquid and non-current assets is evaluated by one or more processors (536). Based upon a predetermined discount factor and/or an acceptable discount factor provided by, for example, the proposed lender/investor, a discounted asset value is calculated. Platform manager 420 may determine whether the applied discount factor and the resulting discounted asset value is acceptable to the trustee and the parties to the proposed secured investment transaction, particularly the lender that is considering providing investment funds for the transaction.

If the resulting discounted asset value is acceptable to the trustee and the lender, for example, and if the proposed secured investment transaction is consummated, platform manager 420 establishes a trust account in database 545 in which at least documents representing a transfer of title of the collateralized illiquid and non-current assets are stored.

In other aspects of this embodiment, closeout processing including returning the documents representing a transfer of title to a selling party may be carried out by platform manager 420 (transfer/closeout process 538) and/or CP trust engine 410 in response to receiving a confirmation over the network from the lender that all pertinent terms and conditions relating to the consummated secured investment transaction have been fulfilled. Such closeout processing 538 may include processing similar or nearly identical to processing involved with repo transactions.

In other aspects of this embodiment, a discount bond may be initiated by platform manager 420 (indemnification process 537) and established in an amount at least equal to the discounted asset value so as to finance repayment of an invested amount in the event of default by seller 450. In this regard, platform manager 420 may also initiate purchase of a discount bond by a third party, e.g., a central banking authority 430 such as the Federal Reserve Bank, in an amount at least equal to the discounted asset value.

In another aspect of this embodiment, and responsive to receiving an indication over the network of a default by a party to the transaction (likely the seller), platform manager 420 may initiate a sale of the illiquid and non-current asset used as collateral to satisfy the debt and to initiate repayment of the discount bond to the third party via transfer/closeout process 538.

In various embodiments of this disclosure, the discounted asset value is generally set at a deeply discounted rate that provides a loan-to-value ratio of less than 50% so that repayment is virtually guaranteed if the collateralized assets must be sold to satisfy the debt. Further in this regard, the discounted asset value may be established for greater security of the lending party/investor by establishing a loan-to-value ratio of about one-third, or 30%. Depending on the nature of the illiquid in non-current assets being proposed as collateral, other loan-to-value ratios may be used.

In another embodiment, a computer-implemented system (400, 500) for managing and indemnifying commercial paper by a trustee over a computer network (520) includes a processor (410 and/or 420) operatively coupled to network (520). One or more memory devices (540) may be operatively coupled to the processor and may include one or more structured databases (545) therein configured to store information relating at least to the commercial paper.

In various aspects of this embodiment, the processor is configured to receive an indication of a proposed short-term secured investment transaction from one or more parties (440, 450, 460, 465) to the transaction. The indication includes identification of one or more illiquid and non-current assets proposed as collateral for the investment transaction. CP trust engine 410 and/or platform manager 420 evaluate an asset value of the illiquid and non-current assets proposed as collateral. Further, CP trust engine 410 and/or platform manager 420 are configured to receive one or more operator inputs, either applied locally, or remotely over network 520. A discount factor is applied to the asset value in response to either the operator input or a predetermined discount factor stored in the structured database 545, or a combination of predetermined discount factors and operator input may be used.

Platform manager 420 and/or CP trust engine 410 may be configured to determine whether the applied discount factor and a resulting discounted asset value is acceptable to the trustee and at least one party to the proposed secured investment transaction, i.e., likely the lender/investor that is considering providing investment funds for the transaction. If the resulting discounted asset value is acceptable to the trustee and the lender, for example, and if the proposed secured investment transaction is consummated, platform manager 420 is configured to establish a trust account in the structured database in which at least documents representing a transfer of title of the collateralized illiquid and non-current assets are stored.

In addition, platform manager 420 may be further configured to provide closeout processing including returning documents representing a transfer of title to selling party 450 in response to receiving a confirmation over network 520 from the lending/investing party (460, 465) that all pertinent terms and conditions relating to the consummated secured investment transaction have been fulfilled. In one or aspects of this embodiment, the closeout processing provided by platform manager 420 may include REPO processing or processing similar to that used in REPO transactions.

In another aspect of this embodiment, platform manager 420 may be further configured to initiate establishment of a discount bond in an amount at least equal to the discounted asset value so as to finance repayment of an invested amount in the event of default by selling party 450.

In yet another aspect of this embodiment, platform manager 420 may be further configured to initiate purchase of a discount bond by a third party in an amount at least equal to the discounted asset value. The third party may be, for example, central banking authority 430 or even a bank responsible for controlling platform manager 420. Further in this regard, and in response to receiving an indication of a default by a party to the transaction (likely the selling party) over network 520, platform manager 420 is configured to initiate a sale of the illiquid and non-current asset used as collateral. In another aspect of this embodiment, and responsive to the sale of the collateral, platform manager 420 may be configured to initiate repayment of the discount bond to the third party.

As discussed in the previous embodiment, the discounted asset value may be selected to provide a loan-to-value ratio of less than 50%, for example, about one-third, or 30% to ensure that a liquidated value of the collateralized asset will at least cover the debt.

In yet another embodiment, a computer-implemented document browser application 535 for a managing and indemnifying commercial paper by a trustee over a computer network includes a processor (420) configured to execute instructions therein such that a software interface with Internet Web browser 535 enables the application to run within a Web browser window so as to allow a user to manage a proposed short-term secured investment transaction. A user interface may be enabled with a host computer system in which allows the user to receive an indication of a proposed short-term secured investment transaction from one or more of parties to the transaction. The indication may include one or more illiquid and non-current assets proposed as collateral for the investment transaction. The browser application may also evaluate an asset value of the assets offered as collateral.

In addition, the user interface may provide one or more operator inputs which interface with the processor to apply a discount factor to the asset value in response to either the operator input or a predetermined discount factor stored in the structured database, or a combination of both operator input and predetermined factors.

In this embodiment, the processor determines whether the applied discount factor and a resulting discounted asset value is acceptable to the trustee and a party to the proposed secured investment transaction that is considering providing investment funds for the transaction, likely the lending/investing party. If the resulting discounted asset value is acceptable to the trustee and the lender, and if the proposed secured investment transaction is consummated, the user interface may be configured to enable establishment of a trust account in the structured database in which documents representing a transfer of title of the one or more illiquid and non-current assets are stored, along with other related documents.

As would be known to a person with ordinary skill in the art, the user interface would include computer executable code therein which, when executed by the host computer system, enables a interactive graphical user interface and includes controls appropriate for managing and indemnifying illiquid and non-current assets used as collateral in a short-term financing arrangement.

Further, given the discussion of the novel and inventive concepts disclosed herein, the various functionality disclosed above could be coded in software using various programming languages and data constructs, as would be known to a person of ordinary skill in the art in light of the disclosure above and drawing figures attached hereto.

The foregoing describes only various aspects of embodiments of the disclosure, and modifications, obvious to those skilled in the art, can be made thereto without departing from the spirit and scope of the disclosed and claimed invention.

APPENDIX
Table 1 - Definitions

| Term | Definition |
|---|---|
| Asset-backed | A form of commercial paper that is collateralized by other financial assets. |
| commercial | ABCPs are typically short-term investments that mature between 90 and |
| paper (ABCP) | 180 days and are typically issued by a bank or other financial institution. |
| | They are designed to be used for short-term financing needs. |
| Basis point | A basis point (often denoted as bp or bps) is a unit that is equal to 1/100^{th} of |
| | a percentage point. It is frequently used to express percentage point |
| | changes of less than 1%. It avoids the ambiguity between relative and |
| | absolute discussions about rates. For example, a “1% increase” in a 10% |
| | interest rate could mean an increase from 10% to 10.1%, or from 10% to |
| | 11%. |
| | It is common practice in the financial industry to use basis points to denote |
| | a rate change in a financial instrument, or the difference (spread) between |
| | two interest rates. This is partially due to the large effect of small changes |
| | to financial instruments. The basis point is also used to calculate changes in |
| | equity indexes and the yield of a fixed-income security. |
| | Since certain loans and bonds may commonly be quoted in relation to some |
| | index or underlying security, they will often be quoted as a spread over (or |
| | under) the index. For example, a loan that bears interest of 0.50% above |
| | LIBOR is said to be 50 basis points over LIBOR. |
| Commercial | In the global money market, commercial paper (CP) is an unsecured |
| Paper | promissory note with a fixed maturity of one to 270 days. Commercial |
| | Paper is a money-market security issued (sold) by large banks and |
| | corporations to get money to meet short term debt obligations (e.g., |
| | payroll), and is only backed by an issuing bank or corporation's promise to |
| | pay the face amount on the maturity date specified on the note. Since it is |
| | not backed by collateral, only firms with excellent credit ratings from a |
| | recognized rating agency will be able to sell their commercial paper at a |
| | reasonable price. Commercial paper is usually sold at a discount from face |
| | value, and carries shorter repayment dates than bonds. The longer the |
| | maturity on a note, the higher the interest rate that must be paid. Interest |
| | rates fluctuate with the market, but are typically lower than banks' rates. |
| | Under American law, commercial paper is a financial instrument that |
| | matures before nine months (270 days), and is only used to fund operating |
| | expenses or current assets (e.g., inventories and receivables) and not used |
| | for financing fixed assets, such as land, buildings, or machinery. By |
| | meeting these qualifications it may be issued without U.S. federal |
| | government regulation, that is, it need not be registered with the U.S. |
| | Securities and Exchange Commission. Commercial paper is a type of |
| | negotiable instrument, where the legal rights and obligations of involved |
| | parties are governed by Articles Three and Four of the Uniform |
| | Commercial Code (UCC), a set of non-federal business laws adopted by |
| | each of the 50 U.S. States. |
| Current Assets | Assets that are expected to be turned into cash, sold, or exchanged within |
| | the normal operating cycle of the firm or one year, whichever is longer |
| Liquid Assets | Cash, checks, and easily-convertible securities available to meet immediate |
| | and emergency needs; business property that can be quickly and easily |
| | converted into cash, such as stock, bank accounts and accounts receivable; |
| | investments capable of being quickly converted into cash without |
| | significant loss, either through their sale or through the scheduled return of |
| | principal at the end of a short time remaining to maturity. |
| Liquidity | Refers to “market liquidity” which is a business, economics or investment |
| | term that refers to an asset's ability to be easily converted (generally to cash) |
| | through an act of buying or selling without causing a significant movement |
| | in the price and with minimum loss of value. An act of exchange of a less |
| | liquid asset with a more liquid asset is called liquidation. |
| Liquidity | The expected amount of liquidity risk based on the mismatch between |
| mismatch | contractual amounts and dates for inflows and outflows. Also called |
| | funding gap, liquidity gap, or term liquidity risk. Liquidity mismatch is one |
| | of the three primary components of liquidity risk, along with contingency |
| | risk and market liquidity risk. |
| Long-term | Resources held for extended use (several accounting periods), because of |
| Assets | their revenue-generating potentials. Examples include land, buildings, |
| | equipment, natural resources, and patents. |
| Marketable | Securities that can be easily converted into cash. Such securities will |
| security | generally have highly liquid markets allowing the security to be sold at a |
| | reasonable price very quickly. |
| Money market | In finance, the money market is the global financial market for short-term |
| | borrowing and lending which provides short-term liquidity funding for the |
| | global financial system. The money market is where short-term obligations |
| | such as Treasury bills, commercial paper and bankers' acceptances are |
| | bought and sold. |
| | Participants borrow and lend for short periods of time, typically up to |
| | thirteen months. Money market trades in short-term financial instruments |
| | commonly called “paper.” This contrasts with the capital market for longer- |
| | term funding, which is supplied by bonds and equity. |
| | The core of the money market consists of banks borrowing and lending to |
| | each other, using commercial paper, repurchase agreements and similar |
| | instruments. These instruments are often benchmarked (i.e. priced over and |
| | above) to the London Interbank Offered Rate (LIBOR). |
| Money market | Also known as principal stability funds, seek to limit exposure to losses due |
| funds | to credit, market, and liquidity risks. Money market funds in the United |
| (“2a-7” funds) | States are regulated by the Securities and Exchange Commission's (SEC) |
| | Investment Company Act of 1940. Rule 2a-7 of the act restricts |
| | investments in money market funds by quality, maturity and diversity. |
| | Under this act, a money fund mainly buys the highest rated debt which |
| | matures in under 13 months. The portfolio must maintain a Weighted |
| | Average Maturity (WAM) of 90 days or less and not invest more than 5% |
| | in any one issuer, except for government and repurchase agreement |
| | securities. Eligible money market securities include commercial paper, |
| | repurchase agreements, short-term bonds or other money funds. Money |
| | market securities must be highly liquid, and have a stable value. |
| Non-current | All other types of assets, that are not current or liquid assets such as fixed |
| Asset | assets, e.g., items of value which the organization has bought and will use |
| | for an extended period of time. Fixed assets normally include items such as |
| | land and buildings, motor vehicles, furniture, office equipment, computers, |
| | fixtures and fittings, and plant and machinery. These often receive |
| | favorable tax treatment (depreciation allowance) over short-term assets. |
| Sale and | Better known as Repurchase Agreements (RPs or “repos”), has a borrower |
| Repurchase | (seller/cash receiver) sell securities for cash to a lender (buyer/cash |
| Agreement | provider) with an agreement to repurchase those securities at a later date for |
| | more cash. The repo rate is the difference between borrowed and paid back |
| | cash expressed as a percentage. |
| Sell/Buy Back | The spot sale and a forward repurchase of a security. |
| Short-term | Typically, financing secured for up to 270 days for commercial paper, but |
| financing | longer periods of time may be used for other short-term assets, e.g., up to 13 |
| | months. |
| Workout | A mutual effort by a financially troubled or in-default borrower and the |
| arrangement | lender to reschedule the loan and/or modify its terms. The borrower's |
| | objective is to avoid foreclosure (which may trigger a bankruptcy) and the |
| | lender's objective is to recoup more money than what would be collectible |
| | from a foreclosure sale. |

What is claimed is:

1. A computer-implemented method of managing and indemnifying commercial paper by a trustee over a computer network, the method comprising:
receiving, in a processor and over the network, an indication of a proposed short-term secured investment transaction from one or more parties to the transaction, said indication including one or more illiquid and non-current assets proposed as collateral for the investment transaction;
evaluating, by the processor, an asset value of the one or more illiquid and non-current assets;
applying, by the processor, a discount factor to the asset value in response to either an operator input or a predetermined discount factor stored in a database, or a combination thereof;
determining, by the processor, whether the applied discount factor and a resulting discounted asset value is acceptable to the trustee and at least one party to the proposed secured investment transaction that is considering providing investment funds for the transaction;
if the resulting discounted asset value is acceptable to the trustee and the at least one party, and if the proposed secured investment transaction is consummated,
establishing, by the processor, a trust account in a database in which at least documents representing a transfer of title of the one or more illiquid and non-current assets are stored.

2. The method of claim 1, further comprising providing, by the processor, closeout processing comprising returning said documents representing a transfer of title to a selling party in response to receiving a confirmation over the network from at least a lending party that all pertinent terms and conditions relating to the consummated secured investment transaction have been fulfilled.

3. The method of claim 2, wherein said closeout processing comprises REPO processing.

4. The method of claim 1, further comprising initiating establishment, by the processor, of a discount bond in an amount at least equal to the discounted asset value so as to finance repayment of an invested amount in the event of default by a selling party.

5. The method of claim 1, further comprising initiating, by the processor, purchase of a discount bond by a third party in an amount at least equal to the discounted asset value.

6. The method of claim 5, wherein, responsive to receiving an indication of a default by a party to the transaction over the network, the processor initiates a sale of the illiquid and non-current asset used as collateral.

7. The method of claim 6, wherein, responsive to a sale of the collateral, the processor initiates repayment of the discount bond to the third party.

8. The method of claim 1, wherein the discounted asset value provides a loan-to-value ratio of less than 50%.

9. The method of claim 8, wherein the discounted asset value provides loan-to-value ratio of about 30%.

10. A computer-implemented system for managing and indemnifying commercial paper by a trustee over a computer network, the method comprising:
a processor operatively coupled to the network;
one or more memory devices operatively coupled to the processor, said one or more memory devices including one or more structured databases therein configured to store information relating at least to the commercial paper;
said processor being configured to:
receive an indication of a proposed short-term secured investment transaction from one or more of parties to the transaction, said indication comprising one or more illiquid and non-current assets proposed as collateral for the investment transaction;
evaluate an asset value of the one or more illiquid and non-current assets;
receive one or more operator inputs;
apply a discount factor to the asset value in response to either the operator input or a predetermined discount factor stored in the structured database, or a combination thereof;
determine whether the applied discount factor and a resulting discounted asset value is acceptable to the trustee and at least one party to the proposed secured investment transaction that is considering providing investment funds for the transaction;
wherein, if the resulting discounted asset value is acceptable to the trustee and the at least one party, and if the proposed secured investment transaction is consummated,
the processor is configured to establish a trust account in the structured database in which at least documents representing a transfer of title of the one or more illiquid and non-current assets are stored.

11. The system of claim 10, wherein the processor is further configured to provide closeout processing comprising returning said documents representing a transfer of title to a selling party in response to receiving a confirmation over the network from at least a lending party that all pertinent terms and conditions relating to the consummated secured investment transaction have been fulfilled.

12. The system of claim 11, wherein said closeout processing provided by said processor comprises REPO processing.

13. The system of claim 10, wherein said processor is further configured to initiate establishment of a discount bond in an amount at least equal to the discounted asset value so as to finance repayment of an invested amount in the event of default by a selling party.

14. The system of claim 10, wherein said processor is further configured to initiate purchase of a discount bond by a third party in an amount at least equal to the discounted asset value.

15. The system of claim 14, wherein, responsive to receiving an indication of a default by a party to the transaction over the network, the processor is configured to initiate a sale of the illiquid and non-current asset used as collateral.

16. The system of claim 15, wherein, responsive to a sale of the collateral, the processor is configured to initiate repayment of the discount bond to the third party.

17. The system of claim 10, wherein the discounted asset value provides a loan-to-value ratio of less than 50%.

18. The method of claim 17, wherein the discounted asset value provides a loan-to-value ratio of about 30%.

19. A computer-implemented document browser application for a managing and indemnifying commercial paper by a trustee over a computer network, the application comprising:
a processor configured to execute instructions therein such that a software interface with an Internet Web browser enables the application to run within a Web browser window so as to allow a user to manage a proposed short-term secured investment transaction;
a user interface enabled with a host computer system through which the user:
receives an indication of a proposed short-term secured investment transaction from one or more of parties to the transaction, said indication comprising one or more illiquid and non-current assets proposed as collateral for the investment transaction;
evaluates an asset value of the one or more illiquid and non-current assets;
provides one or more operator inputs;
applies a discount factor to the asset value in response to either the operator input or a predetermined discount factor stored in the structured database, or a combination thereof;
determines whether the applied discount factor and a resulting discounted asset value is acceptable to the trustee and at least one party to the proposed secured investment transaction that is considering providing investment funds for the transaction;
wherein, if the resulting discounted asset value is acceptable to the trustee and the at least one party, and if the proposed secured investment transaction is consummated,
the user interface is configured to enable establishment of a trust account in a structured database in which at least documents representing a transfer of title of the one or more illiquid and non-current assets are stored,
said user interface further comprising computer executable code therein which, when executed by the host computer system, enables a interactive graphical user interface comprising controls for managing and indemnifying illiquid and non-current assets used as collateral in a short-term financing arrangement.
